(19) United States
(12) Patent Application Publication
(10) Pub. No.: US 2006/0127026 A1
(43) Pub. Date: Jun. 15, 2006

(54) Fiber access terminal

(76) Inventor: Ronald A. Beck, St. Paul, MN (US)

Correspondence Address: MERCHANT & GOULD PC, P.O. BOX 2903, MINNEAPOLIS, MN, 55402-0903, US

(21) Appl. No.: 11/009,952

(22) Filed: Dec. 10, 2004

(51) Int. Cl. G02B 6/00

(52) U.S. Cl. 385/135; 385/134

(57) ABSTRACT

A fiber access terminal and assembly with an end cap and a housing configured for pulling through a conduit. Within an interior of the terminal and the assembly, an input cable is separated into individual fibers which are inserted within fiber pigtails extending from the housing and terminated at connectors. The end cap seals an interior of the housing and the terminal is sized for pulling through a conduit. The connectors may be positioned at two or more different distances from the end cap.

### TECHNICAL FIELD

The present invention generally relates to fiber access terminals and terminal assemblies for extending fiber optic service.

### BACKGROUND

Fiber optic telecommunications connectivity is being increased as part of Fiber-To-The-Household (FTTH) or Fiber-To-The-Premises (FTTP) efforts currently on-going. In these efforts to increase fiber connectivity, the household or small business customers may be less densely located than earlier fiber build-outs to larger businesses or industrial customers. These efforts have given rise to desires for different devices and approaches to extend fibers to these new customers.

Since the customers may be more widely spaced apart, it is desirable to have fiber access terminals that are configured to mount to a multi-strand fiber optic cable with from four to twelve fibers. These fiber access terminals aid in the break out of the individual fibers from the multi-strand cables and preparing them for connection to a customer service or drop cable. The nature and location of the connection with the customer drop cables can be below grade, at grade or aerial. It may be desirable that a fiber access terminal be adapted for use in multiple locations so that the same terminal design may be used for multiple installations. For below grade and at grade installations, it may be desirable that a fiber access terminal be adapted for pulling through an underground conduit. It may be desirable that the cable entry into and exit from the fiber access terminal be sealed against environmental entry.

### SUMMARY

The present invention relates to a fiber access terminal and assembly with an end cap and a housing configured for pulling through a conduit. Within an interior of the terminal and the assembly, an input cable is separated into individual fibers which are inserted within fiber pigtails extending from the housing and terminated at connectors. The end cap seals an interior of the housing and the terminal is sized for pulling through a conduit. The connectors may be positioned at two or more different distances from the end cap.

### BRIEF DESCRIPTION OF THE DRAWINGS

The accompanying drawings, which are incorporated in and constitute a part of the specification, illustrate several aspects of the present invention and together with the description, serve to explain the principles of the invention. A brief description of the drawings is as follows:

FIG. 1 is an exploded side view of a first embodiment of a fiber access terminal assembly according to the present invention.

FIG. 2 is a side view of a second embodiment of a fiber access terminal assembly according to the present invention.

FIG. 3 is a cross-sectional view of the terminal housing of the fiber access terminal of FIG. 2.

FIG. 4 is a side view of a third embodiment of a fiber access terminal in accordance with the present invention.

FIG. 5 is a cross-sectional view of the terminal housing of the fiber access terminal of FIG. 4.

FIG. 6 is an end view of the fiber access terminal assembly of FIG. 2, with twelve fiber optic cable pigtails extending from the fiber access terminal.

FIG. 7 is an end view of a cable tree shown in FIG. 6 with the cables removed and only two cable holding slots illustrated. Outlines of connector positions are shown by dotted lines.

FIG. 8 is an exploded side view of a fourth embodiment of a fiber access terminal assembly according to the present invention, with the cable removed for clarity.

FIG. 9 is a side view of an alternative support member and end cap according to the present invention which may be used with the fiber access terminal of FIGS. 3 and 8.

### DETAILED DESCRIPTION

Reference will now be made in detail to the exemplary aspects of the present invention that are illustrated in the accompanying drawings. Wherever possible, the same reference numbers will be used throughout the drawings to refer to the same or like parts.

Referring now to FIG. 1, a fiber access terminal 10 includes a housing or case 12 and a mating base or end cap 14. A support member 16 may be mounted to end cap 14 and extending into an interior 18 defined within housing 12. Fiber access terminal 10 may be assembled into a terminal assembly 20 including an input optical fiber cable 22 and a plurality of output fiber optic cables or pigtails 24. Each pigtail 24 may be terminated by a fiber optic connector, such as by ruggedized connector 26. Each of the pigtails 24 may be organized and held by a cable tree 28 positioned which may also be positioned about input cable 22. Support member 16 may include one or more cable management structures 30, which may be configured to provide both slack storage as well as bend radius protection. A cable pull attachment point or ring 32 may be included on an end of housing 12 opposite an open end 34. Ring 32 provides a location for attaching a cable or other element to pull terminal assembly 20 through a conduit to extend fiber optic service to locations of customers or potential customers.

As shown in FIG. 1, end cap 14 is sized to fit closely through open end 34 into interior 18 and provide a weather-tight seal for interior 18. Input cable 22 may be a multi-strand optic fiber cable which is separated out into individual strands of fiber 38. Strands 38 may then be directed into pigtails 24 and terminated by connectors 26. Alternatively, support member 16 may be adapted to hold splices and the strands of input cable 22 may be spliced to optical fiber of pigtails 24. Cables 22 and 24 may extend from a base 40 of end cap 14 in a hollowed space 36. Space 36 in base 40 may be filled with epoxy or other adhesive to pot and securely attach these cables to end cap 14 and also seal end cap 14 from weather entry into interior 18.

As shown, terminal assembly 20 may be configured to mount in below-grade installations, at grade installations or in aerial installations.

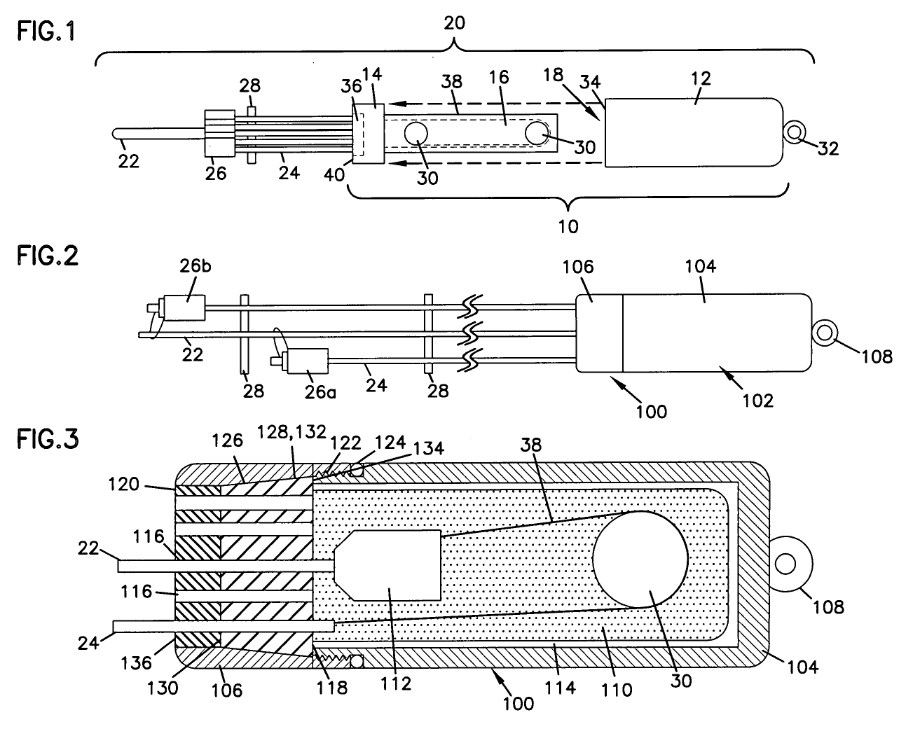

Referring now to FIGS. 2 and 3, a second embodiment of a fiber access terminal assembly 100 includes a fiber access terminal 102 with a housing 104 with a cable pull ring 108 and an end cap 106. A support member 110 is mounted to end cap 106 within an interior defined by housing 104 and closed off by end cap 106. Mounted to support member 110 is a cable fan out chip 112. Multi-strand input cable 22 extends through a centrally located opening 116 which extends from an inner or first end 118 of end cap 106 to an outer or second end 120. The individual strands of optical fiber 38 within input cable 22 are separated from each other and extended about cable management structure 30 of support member 110 before being directed into cable pigtail 24. Fan out chip 212 may also provide a location for securing linear strength members included in input cable 22.

It is anticipated that fiber access terminal 102 and assembly 100 are generally cylindrical in shape, as the conduits through which they may be pulled are typically round. Additional openings 116 extend through end cap 106 and are circumferentially arranged about the central opening 116 through which input cable 22 extends. Only one of the fiber strands 38 and cable pigtails 24 are shown for clarity. End cap 106 is mounted to housing 104 at a threaded interface 122 including external threads on housing 104 and internal threads on end cap 106. In addition, a sealing member, such as an o-ring 124 may be positioned as part of threaded interface 122 to improve the weather-tight seal between end cap 106 and housing 104.

Mounted within end cap 106 and sandwiched between end cap 106 and housing 104 is a plug 126 including a circumferential tapered side wall 128 extending between end 118 and an outer plug end 130. It is anticipated that plug 126 may be made of a resilient deformable material, such as rubber or a similar material. Within end cap 106 is a tapered side wall 132 which generally engages side wall 128 of plug 126. When end cap 106 and housing 104 are threadably engaged, an inner end 134 of housing 104 urges plug 126 into end cap 104. The tapered walls 128 and 132 cooperate to compress plug 126 inwardly and more tightly seal plug 126 about cables 22 and 24 within opening 116. Between outer plug end 130 and second end 120 of end cap 106, a space is defined which may be filled with epoxy or a similar adhesive 136 to firmly attach cables 22 and 24 to end cap 106 and pot the cables to the end cap.

As shown in FIG. 2, connectors 26 may terminate pigtails 24 which are of different lengths. Connector 26a terminates a shorter pigtail 24 while connector 24b terminates a longer pigtail 24. It is anticipated that terminal assembly 100 may include from four to twelve fibers within input cable 22 and have an equal number of pigtails 24 and connectors 26. With currently available and anticipated connectors 26, more than six connectors may not be able to fit side-by-side in a standard conduit size, such as a four inch conduit. When more than six pigtails 24 and connectors 26 are arranged on the same length pigtails 24, it may become difficult or impossible to pull terminal assembly 100 through such a conduit. To permit a greater number of fibers to be accommodated within the conduit, a staggered arrangement of connectors 26 may be used. Only two pigtails 24 and connectors 26 are shown in FIG. 2 in the interest of clarity but it is anticipated that pigtails 24 of at least two different lengths are needed when up to twelve connectors are included in terminal assembly 100. In FIG. 2, if terminal assembly 100 were shown fully populated, as many as six connectors 26 would be included at each of the two lengths of pigtails 24. Flexible pigtails also permit articulation of terminal assembly 100 as assembly 100 passes through curved sections of conduit.

As shown in FIGS. 2 and 3, terminal assembly 100 may be selectively releasably assembled. Since end cap 106 and housing 104 engage each other at threaded interface 122, the seal between the two elements may be broken if access is desired into interior 114.

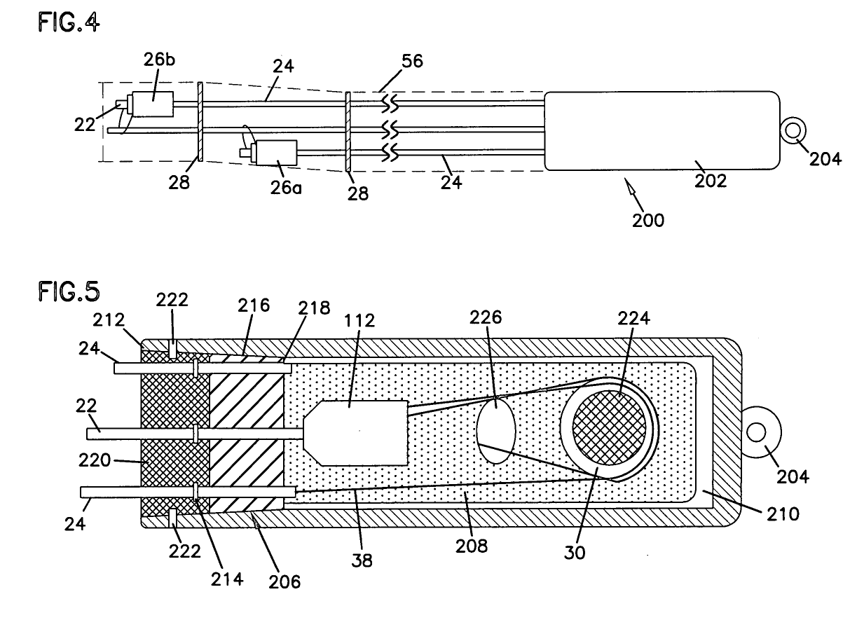

Referring now to FIGS. 4 and 5, a third embodiment of a fiber access terminal assembly 200 includes a housing 202 with a cable pull ring 204 opposite an open end 212 leading into an interior 210 defined within housing 202. An end cap 206 is positioned within interior 210 and closes off access into interior 210 through open end 212. Open end 212 provides entry into interior 210 and defines a wider outer end of a tapered wall 214 extending into interior 210. End cap 206 includes a complimentary shaped outer sidewall 216 that is sized to fit through open end 212 and be compressed as end cap 206 is advanced deeper within interior 210 toward a narrower end 218 of tapered wall 214. Once end cap 206 has been positioned within and appropriately compressed by tapered wall 214 to seal about cables 22 and 24, end cap 206 may be secured within housing 202 by an epoxy or a similar adhesive 220 positioned between end cap 206 and open end 212. Epoxy 220 pots the cables to end cap 206 and housing 202. Positioned along tapered wall 214 may be one or more recessed key slots 222 into which epoxy 220 may flow and harden. These key slots 222 may provide increased mechanical bonding between epoxy 220 and housing 202.

A support member 208 extends from end cap 206 into interior 210. Mounted to support member 208 is a fanout 112 to which input cable 22 extends. The individual fibers 38 of cable 22 are separated and directed into one of the pigtails 24 and terminated at one of the connectors 26. Support member 208 includes at least one cable management structure 30 about which fibers 38 are arranged. Mounted to support member 208 is also a desiccant package 224 which may assist in absorbing any condensation or other moisture which may enter interior 210. Support member 208 also may include an opening 226 to aid in the direction of fibers 38 through support member 208 to a particular pigtail 24.

Once assembled as shown in FIGS. 4 and 5, fiber access terminal 200 is a sealed unit and interior 210 may not be easily accessed for repair or reconfiguration.

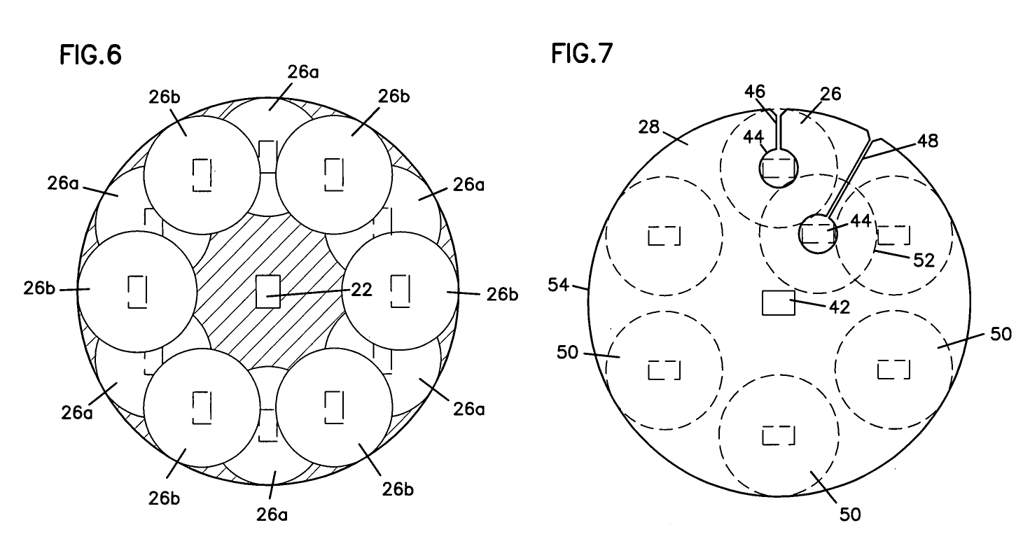

FIG. 6 illustrates the array of fiber optic cable pigtails 24 extending from fiber access terminal 102 (not visible) and held by cable tree 28. Cable tree 28 is shown as defining generally the same diameter as fiber access terminal 102 and is thus sized for pulling through a conduit. As discussed above, six connectors 26a or 26b may fit within the diameter of cable tree 28 about input cable 22. Additional connectors 26a or 26b terminating the same length pigtail would force the array of connectors at that particular length to grow larger than the diameter of cable tree 28 or cable access terminal 102 and might prevent cable terminal assembly 100 from being pulled through the conduit.

FIG. 7 illustrates possible arrangements of cable tree 28 for holding cables 22 and 24. Cable tree 28 includes a central opening 42 through which input cable 22 may be directed. Additional circumferentially spaced apart opening 44 are provided for receiving and holding cable pigtails 24. To arrange cable pigtails 24 as shown in FIG. 6, twelve openings 44 would be required about cable tree 28. A cable 24 may be placed within each of these openings 44 by insertion through a slot 46. As all of the connectors 26 and cable pigtails 24 are generally the same distance from input cable 22 in FIG. 6 (as indicated by the location of the outer ring of connector location in dashed lines marked 50), is anticipated that all twelve openings 44 would be axially arranged generally the same distance from central opening 42 and be accessed by slots generally the same length as slot 46. If it is desired to arrange one or more of the connectors 26 or cable pigtails 24 closer to central opening 42 or input cable 22 (as illustrated by the inner connector location in dashed lines marked 52), opening can be positioned closer to central opening 42 and a longer slot 48 permits entry and removal of cable pigtails 24. Although central opening 42 is shown without an entry slot, it is anticipated that a slot could be extended from an outer edge 54 of cable tree 28 to opening 42. To provide further protection to cables 22 and 24 and to connectors 26, a shroud may be fitted about outer edge 54 and may extend from fiber access terminal 100 (or fiber access 200 or 300, described below) beyond connectors 26. Such a shroud 56 is shown by dashed lines in FIG. 4 and may protect the connectors and cables as fiber access terminal assemblies are pulled through a conduit or otherwise positioned and installed in the field. Also, more than one cable tree 28 may be used for cables 22 and 24.

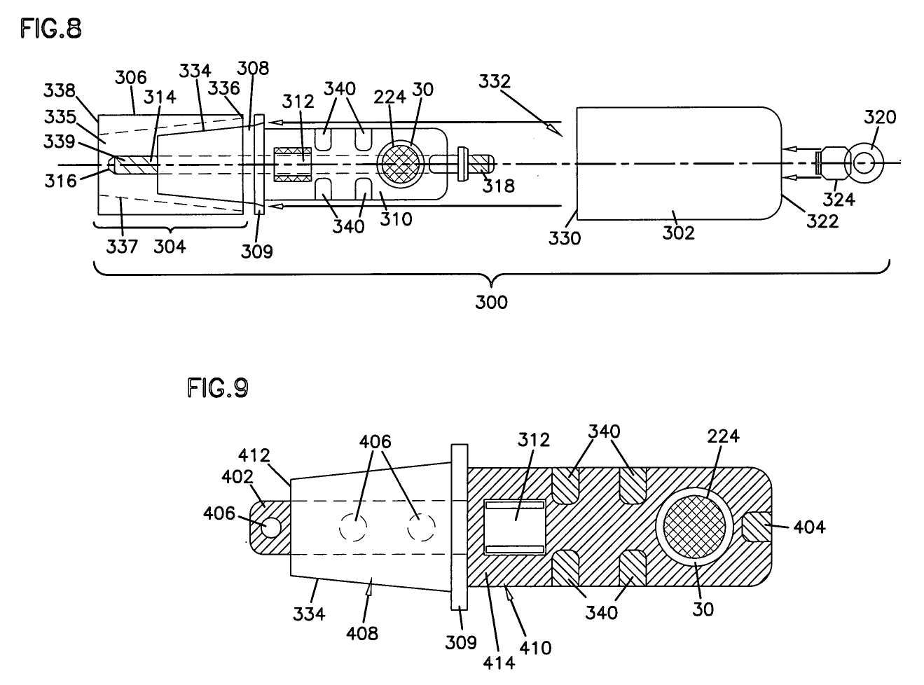

Referring now to FIG. 8, a fourth embodiment of a fiber access terminal 300 includes a housing 302 with an open end 330 allowing entry into an interior 332. An end cap 304 fits within open end 330 and seals interior 332 from weather water or other contaminants. End cap 304 includes an inner plug 308 having a circumferential flange 309 and an outer cap 306. Plug 308 has a tapered side wall 334 extending from a widest point adjacent flange 309 to an opposite narrower end. Mounted to plug 308 opposite side wall 334 is a support member 310 with a splice chip or splice holder 312. Splice holder 312 provides a location for securely positioning splices between individual fibers of multi-strand input cable 22 and cables 38 extending into cable pigtails 24. Splice holder 312 may also provide a location for securing linear strength members included in input cable 22. It is anticipated that at least a portion of fanout 112 or splice holder 312 could alternatively be molded to support member 310. Support member 310 may also include at least one cable management structure 30 and desiccant 224.

A rod 314 extends from a first end 316 through plug 308 and along support member 310 to a second end 318. When assembled, second end 318 will extend through an opening in second end 322 of housing 302 where it is threadably engaged by cable pull fitting 320. Engagement of fitting 320 and second end 318 serves to draw plug 308 into open end 330 so that flange 309 engages an inner wall of interior 332 and seals interior 332. To ensure a weather-tight seal between fitting 320 and housing 302, a sealing member such as an o-ring 324 may be provided on fitting 320. Further, a sealing flange 326 may be provided about rod 314 adjacent second end 318 with a sealing member 328 to seal against an inner wall of closed end 322. It may also be desirable to provide both an interior sealing member 328 and an exterior sealing member 324.

An interior 335 of outer cover 306 includes a tapered inner wall 337 similar to tapered wall 214, shown in FIG. 5, which engages and radially compresses and plug 308 as plug 308 is drawn into open end 336. Outer cover 306 is generally hollow cylindrical cap with a first end 336 sized to fit within open end or against 330 and rest against flange 309. A second end 338 is open for insertion or injection of an adhesive such as epoxy to fill around tapered wall 334 and first end 316 of rod 314. Threads or grooves 339 on first end 316 of rod 314 are provided to bond rod 314 to the epoxy fill inserted into interior 335. An inner wall of outer cap 306 may also include recessed key slots 222 to aid the mechanical connection of the epoxy to outer cap 306.

It is, anticipated that support member 310 is a generally flat structure with openings 340 to permit passage of fibers 38 from one side to the other for insertion into pigtails 24. Rod 314 may be positioned within a center channel formed through support member 310.

An alternative configuration of a support member 410 for use in fiber access terminal assembly 100 is shown in FIGS. 2 and 3, mounted to an alternative end plug 408. Support member 410 includes a first end 402 extending through plug 408 beyond an outer end 412. One or more openings 406 may be provided through first end 402 to aid in securing plug 408 to first end 402 and to provide an increased mechanical bonding between the epoxy, first end 402 and plug 408. Alternatively, plug 408 could be molded about first end 402. On a second end 404 of support member 410 a portion of threaded rod may be inserted and secured to extend through second end 322 of housing 302 and engage fitting 320. It is anticipated that the threaded rod portion mounted to second end 404 of support member 410 will be configured similarly to second end 318 of rod 314.

A method of assembling fiber access terminal 100 is described below. This method will be generally applicable to any of the embodiments described above, with appropriate modifications made for accommodating the different structures and characteristics of each embodiment.
1. Thread an end of a 12-conductor ruggedized fiber optic input cable through a central opening of the cable tree.
2. Thread the input cable through the end cap (epoxy fill end) and through the center hole provided in the tapered (smaller) end of the rubber plug.
3. Strip a portion of the outer jacket from the input cable, exercising care not to damage the inner tube containing the optical fibers.
4. Cut strength members of the input cable so that a short length protrudes from the end of the cable jacket.
5. Cut/remove the center tube so that a portion of tube protrudes from the end of the cable. Exercise care not to damage the optical fibers.
6. Slide a piece of buffer tubing onto each fiber, butting the entry end against the area where the fibers protrude from the cable center tube.
7. Place the fan out chip into place on the support member, place the cable tube end and buffered fibers into their molded-in guide channels within the fan out chip, fill the fan out chip with epoxy, and secure the fan out lid.
8. Place the strength members into the channels provided in the support member and coat them with epoxy.
9. Place the assembly into a curing platen and cure the epoxy. Remove and cool at the end of the epoxy curing cycle.
10. Insert 12 cable pigtails through a) the holes provided in the cable tree, and b) the end cap (epoxy fill end) and through the holes provided in the tapered (smaller) end of the rubber plug. Each pigtail should protrude from larger end of the rubber plug.
11. Position the cable tree offset from the end cap.
12. Cut the far end of each pigtail to the designated breakout length
13. Thread the individual fibers around the radius limiter and into the center tube of each pigtail, exercising care to get the proper fiber into its respective pigtail tube.
14. Check to assure that the far end of each fiber is now protruding from its respective pigtail.
15. Place the rubber plug into the end cap and press it into place (exercise care not to damage the outer seal area).
16. Coat the interface areas of the rubber plug and housing a lubricant.
17. Place the housing over the end cap and rotate the housing to screw it onto the end cap to seat the rubber plug and seals in place.
18. Terminate the fibers and pigtail with connectors.
19. Perform optical checks on the assembly.
20. Remove the housing from the end cap and check the fibers for positioning and the desired amount of routing slack (additional slack can be provided by pushing the pigtails further into the rubber plug).
21. Screw a housing onto the end cap and tighten.
22. Fill the end cap with epoxy to completely encapsulate the input and pigtail cable sections. Place the assembly into an oven and cure the epoxy.
23. Remove the modified housing and inspect for/remove any undesired epoxy that may have leaked past the rubber plug.
24. (optional step: place and secure a disk of desiccant within the center of the radius limiter).
25. Re-assemble the housing onto the end cap and tighten to the specified torque.
26. Perform the final optical performance measurements on the assembly.

The above specification, examples and data provide a complete description of the manufacture and use of the invention. Since many embodiments of the invention can be made without departing from the spirit and scope of the invention, the invention resides in the claims hereinafter appended.

What is claimed is:

1. A fiber access terminal assembly comprising:
an input cable with a plurality of individual strands of optical fiber;
an end cap with a first side and an opposite second side, the input cable extending through an input opening of the end cap from the first side to the second side, the end cap also including a plurality of output openings;
a support member mounted to the second side of the end cap;
a plurality of flexible cable pigtails having a first end within one of the plurality of output openings of the end cap, and a second end to which is mounted a fiber optic connector, each fiber from the input cable optically connected to and terminated at one of the fiber optic connectors;
a housing mounted to the end cap and sealing the support member and the second side of the end cap from the environment and defining a sealed interior, the housing including an open end which fits about and seals to the end cap and an opposite closed end, the closed end including an exterior attachment point.

2. The fiber access terminal of claim 1, wherein the exterior attachment point is configured to receive a tether for pulling the sealed body through a conduit.

3. The fiber access terminal of claim 1, wherein the exterior attachment point is configured to attach the sealed body to a mounting structure.

4. The fiber access terminal of claim 1, wherein the input cable and the plurality of cable pigtails are potted to the end cap with an adhesive.

5. The fiber access terminal of claim 1, wherein the cable pigtails and the input cable are held by a cable tree positioned between the end cap and the connectors.

6. A fiber access terminal assembly comprising:
an input cable with a plurality of individual strands of optical fiber;
an end cap with a first side and an opposite second side, the input cable extending through a central opening of the end cap from the first side to the second side, the end cap also including a plurality of openings spaced apart about the central opening;
a support member mounted to the second side of the end cap;
a plurality of flexible cable pigtails having a first end within one of the plurality of spaced apart openings of the end cap, and a second end to which is mounted a fiber optic connector, each fiber from the input cable optically connected to and terminated at one of the fiber optic connectors;
a housing mounted to the end cap and sealing the support member and the second side of the end cap from the environment and defining a sealed interior.

7. The fiber access terminal of claim 6, wherein the housing is mounted to the end cap by internal threads within an interior of the housing and external threads about an exterior of the end cap.

8. The fiber access terminal of claim 6, further comprising a sealing member is disposed between the housing and the end cap.

9. The fiber access terminal of claim 6, further comprising the end cap made of a deformable material defining a tapered exterior shape with the second end narrower than the first end, and the housing including an open end with a tapered opening having a wider entry for receiving the end cap and a narrower interior, wherein the second end of the end cap may be positioned within the entry and advanced the end cap into the tapered opening so that the exterior shape of the end cap engages the tapered opening and compresses the end cap.

10. The fiber access terminal of claim 6, wherein the end cap is positioned within an interior of the housing through an open end of the housing and the first end of the end cap is potted to the housing by an adhesive.

11. The fiber access terminal of claim 10, wherein the opening of the housing includes at least one recess formed in an inner wall adjacent the opening and the adhesive extends into the at least one recess.

12. The fiber access terminal of claim 6, wherein the housing includes an open end for receiving the end cap and a closed second end, and further comprising a rod extending through the end cap and through the second end of the housing, and a threaded fastener engaging the threaded member outside the interior adjacent the second end of the housing.

13. The fiber access terminal of claim 12, further comprising the rod fixed with respect to the end cap by potting with an adhesive at the first side of the end cap.

14. The fiber access terminal of claim 6, wherein the housing includes an open end for receiving the end cap and a closed second end, and further comprising a threaded member extending from the support member through the second end of the housing and engaging a threaded fitting outside the second end.

15. The fiber access terminal of claim 6, further comprising a fan out mounted to the support member, the individual strands of fiber from the input cable extend through the fan out and each individual strand of fiber extends into one of the cable pigtails and is terminated at the fiber optic connector of that pigtail.

16. The fiber access terminal of claim 6, further comprising a splice holder mounted to the support member, the individual strands of fiber of the input cable each extending to the splice holder and spliced to a second fiber extending into one of the cable pigtails and terminated at the fiber optic connector.

17. The fiber access terminal of claim 6, further comprising at least one cable management structure mounted to the support member providing slack storage and bend radius protection for the strands of optical fiber within the interior.

18. The fiber access terminal assembly of claim 6, further comprising a cable tree positioned about the input cable and the fiber pigtails between the end cap and the connectors.

19. The fiber access terminal assembly of claim 18, wherein a first portion of the plurality of fiber pigtails are shorter in length from the end cap than a second portion of the plurality of the fiber pigtails, and a second cable tree is mounted about the input cable and the second portion of the plurality of fiber pigtails between the connectors of the first portion of the plurality of fiber pigtails and the connectors of the second portion of the plurality of fiber pigtails.

20. The fiber access terminal assembly of claim 6, wherein a first portion of the plurality of fiber pigtails are shorter in length from the end cap than a second portion of the plurality of the fiber pigtails.

21. A fiber access terminal enclosure comprising:
a housing with a first open end and a second closed end defining an interior with an interior wall;
an end cap with a first end and a second end and a circumferential side wall extending between the ends;
the second end of the end cap sized to be received at the first open end of the housing with the side wall sealing against the interior wall;
a support member mounted to the second end of the end cap within the interior, the support structure including slack storage and bend radius protection for optical fiber;
a input opening through the end cap from the first end to the second end for entry of a fiber input cable into the interior;
a plurality of output openings and a flexible cable pigtail extending through the end cap beyond the second end from each of the output openings;
a pull cable attachment attached to the second end of the housing.

22. The fiber access terminal enclosure of claim 21, wherein the housing is sized to be pulled through a four inch conduit.

23. The fiber access terminal enclosure of claim 21, the housing further comprising a threaded portion of the interior wall and the end cap including a mating threaded portion of the side wall, the two threaded portions engaging each other to selectively releasably hold the end cap to the housing.

24. The fiber access terminal enclosure of claim 23, further comprising a sealing member positioned between the end cap and the housing.

25. The fiber access terminal enclosure of claim 21, wherein the end cap includes an outer shell and a compression insert within the outer shell portion, the outer shell including internal threads adjacent the second end and the housing includes mating external threads adjacent the open end, an interior of the outer shell of the end cap including a tapered inner wall extending from a wider second end to a narrower first end and the compression insert with a tapered side wall extending from a wider second end to a narrower first end, wherein mating of the threaded portions of the outer shell and the housing urges the compression insert from the second end toward the first end and the compression insert is compressed by the tapered inner wall of the outer shell of the end cap.

26. The fiber access terminal enclosure of claim 21, wherein the side wall of the end cap is tapered from the wider first end to the narrower second end and the interior wall is tapered from the wider entry into the interior.

27. The fiber access terminal enclosure of claim 21, further comprising a splice chip mounted to the support member.

28. The fiber access terminal enclosure of claim 21, further comprising a fanout mounted to the support member.

25. A method of assembling a fiber access terminal comprising:
providing an end cap and a housing with an open end sized to mate with the end cap and a closed second end including a cable pull attachment;
extending a multi-strand optical fiber input cable through the end cap from an outer end to beyond an inner end;
separating each of the strands of optical fiber within the input cable on the inner end of the end cap;
extending the strands of optical fiber through a support member mounted to the inner end of the end cap;
extending a plurality of pigtail cable housings through the end cap from the inner end to beyond the outer end of the end cap;
extending each of the strands of optical fiber from the support structure into one of the pigtail cable housings from the inner end of the end cap;
terminating the fiber and the pigtail cable housing at a connector beyond the outer end of the end cap;
mating the end cap with the open end of the housing so that the end cap and housing engage each other to seal an interior of the housing.

26. The method of claim 25 further providing the end cap with an inner rubber plug and the support member mounted to the rubber plug, the method further comprising extending the input fiber input cable and fiber pigtail housing through thee rubber plug.

27. The method of claim 26 wherein the end cap includes a threaded portion and the open end of the housing includes a mating threaded portion, the method further comprising threadably engaging the end cap and the housing so that the rubber plug is captured within the end cap and forms a seal of the open end of the housing.

28. The method of claim 26, wherein the end cap includes an inner tapered wall and the rubber plug includes a matching tapered side wall, the method further comprising engaging the inner tapered wall and the tapered side wall and compressing the rubber plug about the input cable and the cable pigtail housings.

29. The method of claim 26, wherein the end cap is a rubber plug with a tapered side wall and the housing includes an inner tapered wall, the method further comprising inserting the rubber plug within the open end of the housing into an interior of the housing with the outer end of the plug entirely within the open end and inserting an adhesive within the open end of the housing atop the second end of the rubber plug.

30. The method of claim 26, further comprising terminating a first portion of the plurality of fiber pigtails at a shorter length than a second portion of the plurality of fiber pigtails.

31. The method of claim 26, further comprising extending the fiber input cable through a cable tree and inserting the fiber pigtails extending from the outer end of the end cap into the cable tree.

32. The method of claim 31, further comprising terminating a first portion of the plurality of fiber pigtails at a shorter length than a second portion of the plurality of fiber pigtails and a second cable tree is positioned about the input cable and the second portion of the plurality of fiber pigtails between the connectors of the first portion and the connectors of the second portion.

33. A fiber access terminal assembly comprising:
an end cap and a housing configured and sized for pulling through a conduit, the housing defining an interior;
an input cable entering the interior through the end cap and separated into a plurality of individual optical fibers;
the individual optical fibers each inserted within one of a plurality of output cable pigtails extending through the end cap;
the optical fibers and output cable pigtails each terminated at a connector outside the interior; and,
the end cap engaged with an end of the housing and sealing the interior.
